(19) United States
(12) Patent Application Publication
(10) Pub. No.: US 2020/0125927 A1
(43) Pub. Date: Apr. 23, 2020

(54) MODEL TRAINING METHOD AND APPARATUS, AND DATA RECOGNITION METHOD

(71) Applicant: Samsung Electronics Co., Ltd., Suwon-si (KR)

(72) Inventor: Hogyeong KIM, Daejeon (KR)

(73) Assignee: Samsung Electronics Co., Ltd., Suwon-si (KR)

(21) Appl. No.: 16/356,264

(22) Filed: Mar. 18, 2019

(30) Foreign Application Priority Data
Oct. 22, 2018 (KR) 10-2018-0125758

(51) Int. Cl. G06N 3/04; G06N 3/08

(52) U.S. Cl. CPC G06N 3/0454; G06N 3/084

(57) ABSTRACT

A model training method and apparatus, and a data recognition method are provided. The model training method includes determining a loss function by reflecting an error rate between a recognition result of a teacher model and a recognition result of a student model to the loss function, and training the student model based on the loss function.

### CROSS-REFERENCE TO RELATED APPLICATIONS

This application claims the benefit under 35 USC § 119(a) of Korean Patent Application No. 10-2018-0125758, filed on Oct. 22, 2018, in the Korean Intellectual Property Office, the entire disclosure of which is incorporated herein by reference for all purposes.

### BACKGROUND

### 1. Field

The following description relates to methods and apparatuses for training a model and data recognition.

### 2. Description of Related Art

Research is being actively conducted to classify input patterns in groups so that efficient pattern recognition may be performed on computers. The research includes research on an artificial neural network (ANN) obtained by modeling pattern recognition characteristics using by mathematical expressions. To address the above issue, the ANN employs an algorithm that mimics abilities to learn. The ANN generates mapping between input patterns and output patterns using the algorithm, and a capability of generating the mapping is expressed as a learning capability of the ANN. Also, the ANN has a generalization capability to generate a relatively correct output with respect to an input pattern that has not been used for training based on a result of the training. Also, research is being conducted to miniaturize the ANN and to maximize a recognition rate of the ANN.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a model training method including determining a loss function based on an error rate between a recognition result of a teacher model and a recognition result of a student model, and training the student model based on the loss function.

The determining of the loss function may include determining the loss function so that a contribution rate of the teacher model to training of the student model may be increased in response to an increase in the error rate between the recognition result of the teacher model and the recognition result of the student model.

A contribution of the error rate between the recognition result of the teacher model and the recognition result of the student model may be selectively adjusted based on an error between a correct answer and a recognition result of the student model.

The determining of the loss function may include determining the loss function so that a contribution rate of a loss between the recognition result of the teacher model and the recognition result of the student model to the loss function may be increased in response to an increase in the error rate between the recognition result of the teacher model and the recognition result of the student model.

The error rate between the recognition result of the teacher model and the recognition result of the student model may be updated at a training epoch of the student model.

The loss function may be determined based on an error rate between a correct answer and the recognition result of the teacher model.

The determining of the loss function may include determining the loss function so that a contribution rate of the teacher model to training of the student model may be increased in response to a decrease in the error rate between the correct answer and the recognition result of the teacher model.

The determining of the loss function may include determining the loss function by applying a first factor to the error rate between the recognition result of the teacher model and the recognition result of the student model, wherein the first factor may be controlled so that a contribution of the teacher model to training of the student model decreases in response to an increase in a training epoch of the student model.

The loss function may be based on a loss between a correct answer and the recognition result of the teacher model.

A contribution of the loss between the correct answer and the recognition result of the teacher model and the loss between the recognition result of the teacher model and the recognition result of the student model to the loss function may be adjusted by a second factor, wherein the second factor may be controlled so that a contribution of the teacher model to training of the student model decreases and a contribution of the correct answer increases, in response to an increase in a training epoch of the student model.

In another general aspect, there is provided a model training method including determining a loss function based on an error rate between a correct answer and a recognition result of a teacher model, and training a student model based on the loss function.

The determining of the loss function may include determining the loss function so that a contribution rate of the teacher model to training of the student model may be increased, in response to a decrease in the error rate between the correct answer and the recognition result of the teacher model.

A contribution of the error rate between the correct answer and a recognition result of a teacher model may be selectively adjusted based on an error between a correct answer and a recognition result of the student model.

The determining of the loss function may include determining the loss function so that a contribution rate of a loss between the correct answer and the recognition result of the teacher model to the loss function may be increased, in response to a decrease in the error rate between the correct answer and the recognition result of the teacher model.

The loss function may be determined based on an error rate between the recognition result of the teacher model and a recognition result of the student model.

In another general aspect, there is provided a data recognition method including receiving target data to be recognized, and recognizing the target data using a student model, wherein the student model is trained based on a loss function determined by reflecting an error rate between a recognition result of a teacher model and a recognition result of the student model.

In another general aspect, there is provided a model training apparatus including a memory configured to store a teacher model and a student model, and a processor configured to determine a loss function based on an error rate between a recognition result of the teacher model and a recognition result of the student model, and to train the student model based on the loss function.

The processor may be configured to determine the loss function so that a contribution rate of the teacher model to training of the student model may be increased, in response to an increase in the error rate between the recognition result of the teacher model and the recognition result of the student model.

The processor may be configured to determine the loss function by reflecting an error rate between a correct answer and the recognition result of the teacher model to the loss function.

The processor may be configured to determine the loss function by applying a first factor to the error rate between the recognition result of the teacher model and the recognition result of the student model, wherein the first factor may be controlled so that a contribution of the teacher model to training of the student model decreases, in response to an increase in a training epoch of the student model.

Other features and aspects will be apparent from the following detailed description, the drawings, and the claims.

### BRIEF DESCRIPTION OF THE DRAWINGS

FIG. 1 illustrates an example of a teacher model and a student model.

FIG. 2 illustrates an example of a neural network.

FIG. 3 illustrates an example of a process of training a student model.

FIGS. 4 and 5 illustrate examples of processes of reflecting an error rate to a loss function.

FIG. 6 illustrates an example of a factor applied to a loss function.

FIG. 7 is a diagram illustrating an example of a process of training a student model.

FIG. 8 illustrates an example of a model training method.

FIG. 9 illustrates an example of a data recognition method.

FIG. 10 illustrates an example of a model training apparatus.

FIG. 11 illustrates an example of a data recognition apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When a part is connected to another part, it includes not only a case where the part is directly connected but also a case where the part is connected with another part in between. Also, when a part includes a constituent element, other elements may also be included in the part, instead of the other elements being excluded, unless specifically stated otherwise. Although terms such as “first,” “second,” “third” “A,” “B,” (a), and (b) may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

If the specification states that one component is “connected,” “coupled,” or “joined” to a second component, the first component may be directly “connected,” “coupled,” or “joined” to the second component, or a third component may be “connected,” “coupled,” or “joined” between the first component and the second component. However, if the specification states that a first component is “directly connected” or “directly joined” to a second component, a third component may not be “connected” or “joined” between the first component and the second component. Similar expressions, for example, “between” and “immediately between” and “adjacent to” and “immediately adjacent to,” are also to be construed in this manner.

The use of the term ‘may’ herein with respect to an example or embodiment, e.g., as to what an example or embodiment may include or implement, means that at least one example or embodiment exists where such a feature is included or implemented while all examples and embodiments are not limited thereto.

Hereinafter, examples will be described in detail with reference to the accompanying drawings, and like reference numerals in the drawings refer to like elements throughout.

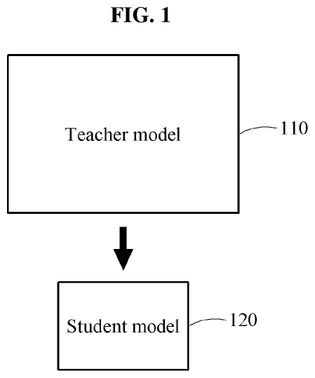

FIG. 1 illustrates an example of a teacher model 110 and a student model 120.

In an example, the teacher model 110 and the student model 120 are neural networks that recognize the same target and that are different from each other in size. A neural network is a recognition model that uses a large number of artificial neurons connected via edges.

The teacher model 110 is a model that recognizes target data with a high accuracy based on a sufficiently large number of features extracted from the target data, and has a size that is greater than that of the student model 120. For example, the teacher model 110 may include a greater number of layers and a greater number of nodes than those of the student model 120, or a combination thereof.

The student model 120 is a neural network that has a size less than that of the teacher model 110, and accordingly a recognition speed of the student model 120 is greater than that of the teacher model 110. The student model 120 is trained based on the teacher model 110 and the output data of the teacher model 110 that is output in response to input data. The output data of the teacher model 110 includes, for example, a value of logit and a probability value output from the teacher model 110, or an output value of a classification layer derived from a hidden layer of the teacher model 110.

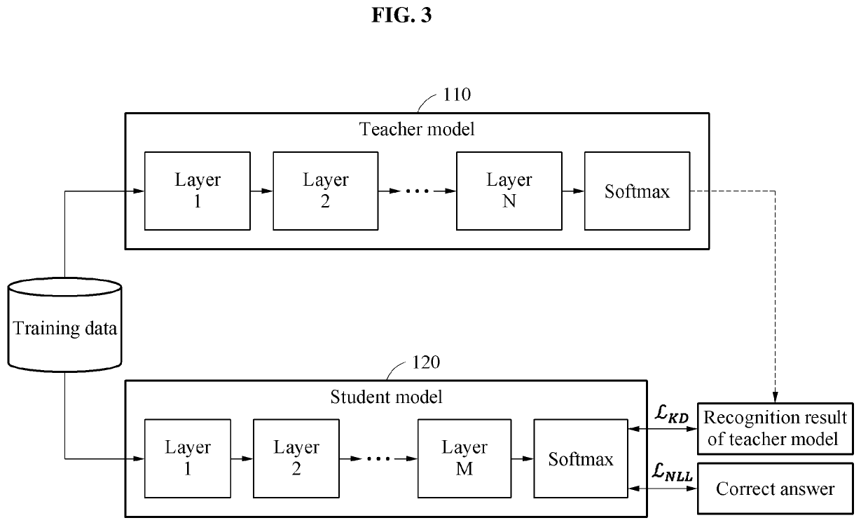

By training the student model 120 using the teacher model 110, the student model 120 may output the same value as that of the teacher model 110 and have a greater recognition speed than that of the teacher model 110. The above training scheme is referred to as a “model compression.” An example of a model compression will be further described below with reference to FIG. 3.

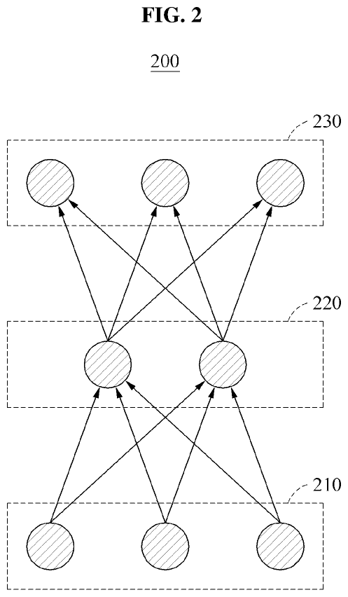

FIG. 2 illustrates an example of a neural network 200.

A teacher model and a student model are neural networks 200 of different sizes. A method and apparatus for recognizing data based on the neural network 200, and a method and apparatus for training the neural network 200 are provided. A neural network 200 corresponds to an example of a deep neural network (DNN) or an n-layer neural network. The DNN includes, for example, a fully connected network, a convolutional neural network (CNN), a deep convolutional network, or a recurrent neural network (RNN), a deep belief network, a bi-directional neural network, a restricted Boltzman machine, or may include different or overlapping neural network portions respectively with full, convolutional, recurrent, and/or bi-directional connections. The neural network 200 maps, based on deep learning, input data and output data that are in a non-linear relationship, to perform, for example, an object classification, an object recognition, a speech recognition, or an image recognition. In an example, deep learning is a machine learning scheme to solve a problem such as a recognition of speech or images from a big data set. Through supervised or unsupervised learning in the deep learning, input data and output data are mapped to each other.

In the following description, a recognition includes a verification and an identification. The verification is an operation of determining whether input data is true or false, and the identification is an operation of determining which one of a plurality of labels is indicated by input data.

Referring to FIG. 2, the neural network 200 includes a plurality of layers that each include a plurality of nodes. Also, the neural network 200 includes connection weights that connect a plurality of nodes included in one of the plurality of layers to nodes included in another layer.

For example, the neural network 200 includes an input layer 210, a hidden layer 220 and an output layer 230. The input layer 210 receives an input to perform training or recognition, and transfers the input to the hidden layer 220. The output layer 230 generates an output of the neural network 200 based on a signal received from the hidden layer 220. The hidden layer 220 is located between the input layer 210 and the output layer 230, and changes a training input of training data received via the input layer 210 to a value that is relatively more easily predictable.

Input nodes included in the input layer 210 and hidden nodes included in the hidden layer 220 are connected to each other via edges with connection weights. Also, hidden nodes included in the hidden layer 220 and output nodes included in the output layer 230 are connected to each other via edges with connection weights.

The neural network 200 may include a plurality of hidden layers, although not shown. A neural network including a plurality of hidden layers is referred to as a DNN. Training of the DNN is also referred to as “deep learning.” For example, a teacher model that is greater in size than the student model may include a larger number of hidden layers than that of the student model.

A model training apparatus trains the neural network 200 through supervised learning. The model training apparatus is implemented by, for example, on a hardware module. In an example, the supervised learning is a scheme of inputting a training input of training data to the neural network 200 and updating connection weights of edges so that output data corresponding to a training output of the training data is output. In an example, the training data is data including a pair of a training input and a training output. Although the structure of the neural network 200 is expressed as a node structure in FIG. 2, examples are not limited to the node structure. For example, various data structures may be used to store a neural network in a memory storage.

In an example, the model training apparatus determines parameters of nodes included in a neural network using a gradient descent scheme based on a loss that is propagated backwards to the neural network and based on output values of the nodes. For example, the model training apparatus updates connection weights between nodes through loss backpropagation learning. The loss backpropagation learning is a scheme of estimating a loss by a forward computation of given training data, propagating the estimated loss backwards from an output layer to a hidden layer and an input layer, and updating connection weights to reduce a loss. The neural network 200 is processed in an order of the input layer 210, the hidden layer 220, and the output layer 230. In an example, the connection weights in the loss backpropagation learning are updated in an order of the output layer 230, the hidden layer 220 and the input layer 210. For example, at least one processor uses a buffer memory configured to store layers or calculation data to process a neural network in a desired order.

The model training apparatus defines an objective function to measure how close currently set connection weights are to an optimal value, continues to change the connection weights based on a result of the objective function, and repeatedly performs training. For example, the objective function is a loss function used to calculate a loss between an expected value to be output and an actual output value based on a training input of training data in the neural network 200. The model training apparatus updates the connection weights to reduce a value of the loss function. An example of a loss function will be described below with reference to FIG. 3.

FIG. 3 illustrates an example of a process of training a student model.

The student model 120 is trained using the teacher model 110 based on a knowledge distillation for propagating knowledge between two different neural networks. The knowledge distillation is an example of a model compression.

In an example, a loss function used in a training process is determined based on a loss between a correct answer and a recognition result of a teacher model and a loss between the recognition result of the student model and a recognition result of a teacher model. The recognition result of the student model represents output data that is output from the student model 120 when a training input of training data is input to the student model 120. The recognition result of the teacher model represents output data that is output from the teacher model 110 when a training input of training data is input to the teacher model 110. The correct answer represents a training output corresponding to the training input of the training data.

In an example, a loss function is expressed by Equation 1 as shown below.

[symbol]

=(1−α) [symbol] _{NLL}+α*k* [symbol] _{KD} [Equation 1]

In Equation 1, [symbol] denotes a loss function used to train a student model, [symbol] _{NLL} denotes a loss function used to calculate a loss between a correct answer and a recognition result of a teacher model, and [symbol] _{KD} denotes a loss function used to calculate a loss between the recognition result of the student model and a recognition result of a teacher model. α denotes a vector to adjust a percentage of the loss between the correct answer and the recognition result of the student model and the loss between the recognition result of the student model and the recognition result of the teacher model being reflected to the loss function.

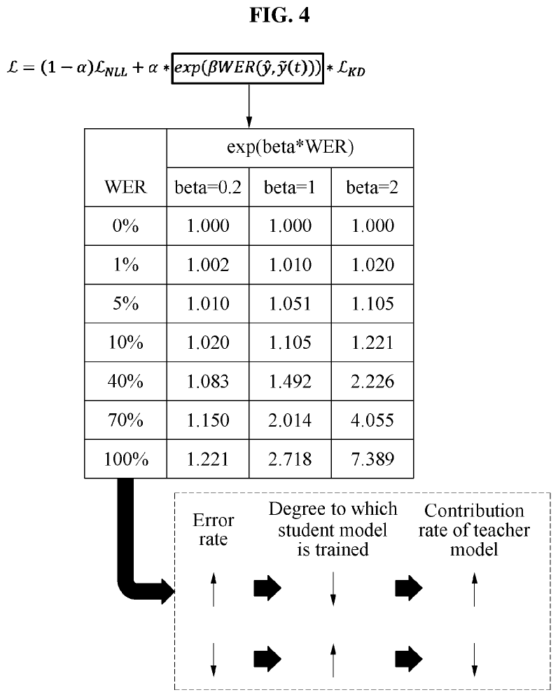

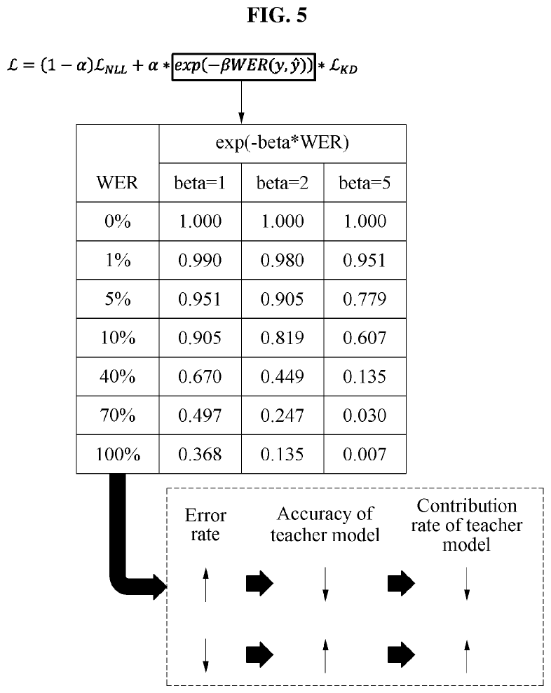

In addition, k denotes a factor to adjust a degree to which the loss between the recognition result of the student model and the recognition result of the teacher model is reflected to the loss function. Based on k, a level of contribution of the teacher model to training of the student model is adjusted. For example, k includes any one or any combination of an error rate between the recognition result of the teacher model and the recognition result of the student model and an error rate between the correct answer and the recognition result of the teacher model, which will be further described below with reference to FIGS. 4 and 5.

FIGS. 4 and 5 illustrate examples of processes of reflecting an error rate to a loss function.

FIG. 4 illustrates an example of reflecting an error rate between a recognition result of a teacher model and a recognition result of a student model to a loss function. The loss function reflecting the error rate between the recognition result of the teacher model and the recognition result of the student model is determined using Equation 2 as shown below.

[symbol]

=(1−α) [symbol] _{NLL}+α*exp(βWER(ŷ,\tilde{y}(t)))* [symbol] _{KD} [Equation 2]

In Equation 2, ŷ denotes the recognition result of the teacher model and \tilde{y}(t) denotes a recognition result of the student model at a training epoch t. Also, WER(ŷ,\tilde{y}(t)) denotes the error rate between the recognition result of the teacher model and the recognition result of the student model, and WER indicates a word error rate. In addition, exp( ) denotes an exponential function.

A degree to which the student model is trained is determined based on the error rate between the recognition result of the teacher model and the recognition result of the student model. In an example, a high error rate between the recognition result of the teacher model and the recognition result of the student model indicates that the student model fails to output the same recognition result as that of the teacher model, and thus, the degree to which the student model is trained is low. In this example, a loss function is determined so that a contribution rate of the teacher model to training of the student model is increased. Thus, the training is promoted such that the student model outputs the same recognition result as that of the teacher model.

In another example, a low error rate between the recognition result of the teacher model and the recognition result of the student model indicates that the student model is outputting the same recognition result as that of the teacher model, and thus, the degree to which the student model is trained is high. When the degree to which the student model is trained is high, the student model needs to be trained to output the same recognition result as the correct answer instead of the recognition result of the teacher model. In this example, a loss function is determined so that a contribution rate of the teacher model to training of the student model is decreased. Thus, a degree of completion of the training of the student model is increased.

As described above, the error rate between the recognition result of the teacher model and the recognition result of the student model is reflected to the loss function. Thus, information about whether the student model is properly trained based on a performance of the teacher model may be used to more efficiently perform the training.

FIG. 4 illustrates examples of values of exp(−βWER(y,ŷ)) determined based on an error rate and β. When the error rate or β increases, exp(−βWER(y,ŷ)) increases, and thus a loss between the recognition result of the teacher model and the recognition result of the student model is significantly reflected to the loss function. Therefore, the student model is trained to output the same recognition result as that of the teacher model.

FIG. 5 illustrates an example of reflecting an error rate between a correct answer and a recognition result of a teacher model to a loss function. The loss function reflecting the error rate between the correct answer and the recognition result of the teacher model is determined using Equation 3 as shown below.

[symbol]

=(1−α) [symbol] _{NLL}+α*exp(−βWER(y,ŷ))* [symbol] _{KD} [Equation 3]

In Equation 3, y denotes the correct answer, and WER(y,ŷ) denotes the error rate between the correct answer and the recognition result of the teacher model.

An accuracy of the teacher model is determined based on the error rate between the correct answer and the recognition result of the teacher model. In an example, a high error rate between the correct answer and the recognition result of the teacher model indicates that the teacher model fails to output the same recognition result as the correct answer, and thus the accuracy of the teacher model is low. In this example, the loss function is determined so that a contribution rate of the teacher model to training of the student model decreases, and thus it is possible to perform the training so that the student model outputs a recognition result similar to the correct answer instead of the recognition result of the teacher model.

In another example, a low error rate between the correct answer and the recognition result of the teacher model indicates that the teacher model outputs the same recognition result as the correct answer, and thus the accuracy of the teacher model is high. In this example, a loss function is determined so that a contribution rate of the teacher model to training of the student model increases, and thus it is possible to promote the training so that the student model outputs the same recognition result as that of the teacher model.

As described above, the error rate between the correct answer and the recognition result of the teacher model is reflected to the loss function, and thus a degree to which the teacher model contributes to the training of the student model is adjusted based on the accuracy of the teacher model assuming that the teacher model may not be perfect. Also, it is possible to effectively prevent training from being performed to actively train an incorrect teacher model.

FIG. 5 illustrates examples of values of exp(−βWER(y,ŷ)) determined based on an error rate and β. When the error rate or β decreases, exp(−βWER(y,ŷ)) increases, and a loss between the recognition result of the teacher model and the recognition result of the student model is reflected to the loss function. Therefore, the student model is trained to output the same recognition result as that of the teacher model.

In another example, the error rate between the recognition result of the teacher model and the recognition result of the student model and the error rate between the correct answer and the recognition result of the teacher model are simultaneously reflected to the loss function. In this example, the loss function is determined using Equation 4 as shown below.

[symbol]

=(1−α) [symbol] _{NLL}+α*exp(−βWER(y,ŷ))*exp(βWER(ŷ,\tilde{y}(t)))* [symbol] _{KD} [Equation 4]

In Equation 4, both the error rate between the recognition result of the teacher model and the recognition result of the student model and the error rate between the correct answer and the recognition result of the teacher model are reflected to the loss function. Thus, it is possible to train the student model based on the accuracy of the teacher model as well as the degree to which the student model is trained.

Thus, it is possible to apply any one or any combination of the error rate between the recognition result of the teacher model and the recognition result of the student model and the error rate between the correct answer and the recognition result of the teacher model to the loss function, and examples are not limited thereto.

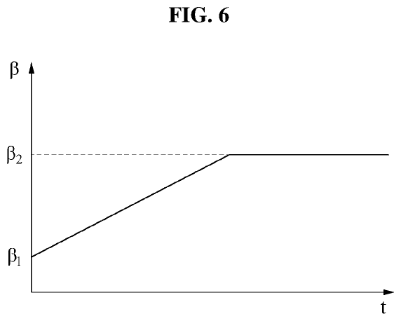

FIG. 6 illustrates an example of a factor applied to a loss function.

At the beginning of training, it is important to train a student model to output the same recognition result as that of the teacher model. When the training is performed at a level so that the student model outputs the same recognition result as that of the teacher model, training the student model to output a correct answer is important. In an example, a training objective of the student model based on training stages is changed by controlling a factor applied to a loss function.

As described above, the loss function is determined based on a loss between the correct answer and the recognition result of the teacher model and a loss between the recognition result of the student model and the recognition result of the teacher model, and at least one factor is applied to the losses.

In an example, β of FIGS. 4 and 5 is applied as a first factor to the loss function. β is a factor applied to the loss between the recognition result of the student model and the recognition result of the teacher model. For example, when both β and the error rate between the correct answer and the recognition result of the teacher model are applied to the loss function as shown in FIG. 5, and when β increases, the loss between the recognition result of the student model and the recognition result of the teacher model is less reflected to the loss function. In this example, β gradually increases from β₁ and converges to β₂. Also, any example in which an initial value increases up to an upper limit value over time is applicable, and examples are not limited thereto.

When both β and the error rate between the recognition result of the teacher model and the recognition result of the student model are applied to the loss function as shown in FIG. 4, and when β decreases, the loss between the recognition result of the student model and the recognition result of the teacher model is less reflected to the loss function. In this example, β gradually decreases from an initial value and converges to a lower limit value. Also, any example in which an initial value decreases and does not decrease below a lower limit value over time is applicable, and examples are not limited thereto.

In another example, α of Equation 1 is applied as a second factor to the loss function. α is a factor used to adjust a percentage of the loss between the correct answer and the recognition result of the student model and the loss between the recognition result of the student model and the recognition result of the teacher model being reflected to the loss function, and has a value of “0” to “1.” α is changed so that the loss between the correct answer and the recognition result of the student model is more significantly reflected to the loss function than the loss between the recognition result of the student model and the recognition result of the teacher model over time. For example, α is controlled to have a value from an initial value close to “1” to a final value close to “0.” Also, any example of significantly reflecting the loss between the correct answer and the recognition result of the student model to the loss function over time is applicable, and examples are not limited thereto.

FIG. 7 is a diagram illustrating an example of a process of training a student model. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. One or more blocks of FIG. 7, and combinations of the blocks, can be implemented by special purpose hardware-based computer, such as a processor, that perform the specified functions, or combinations of special purpose hardware and computer instructions. In addition to the description of FIG. 7 below, the descriptions of FIG. 1-6 are also applicable to FIG. 7, and are incorporated herein by reference. Thus, the above description may not be repeated here.

A model training apparatus trains the student model through operations 710 through 790. In the process of FIG. 7, a trained teacher model θ_{T} and a training data pair (s, y) are used. In the training data pair (s, y), s denotes a training input of training data, and y denotes a correct answer as a training output corresponding to the training input s.

In operation 710, the model training apparatus acquires a recognition result ŷ of the teacher model θ_{T} by inputting the training input s to the teacher model θ_{T}.

In operation 720, the model training apparatus calculates an error rate WER(y, ŷ) between the correct answer y and the recognition result ŷ. The calculated error rate is reflected to a loss function used for training a student model, to determine the loss function.

In operation 730, the model training apparatus trains a student model θ_{S}. To train the student model θ_{S}, the loss function reflecting the error rate calculated in operation 720 is used.

In operation 740, the model training apparatus determines whether a training epoch t is less than a maximum epoch. For example, when the training epoch t is determined to be less than the maximum epoch, operation 750 is performed.

In operation 750, the model training apparatus determines whether the training epoch t corresponds to a multiple of a check epoch. For example, when the check epoch is set to “1,000,” in operation 750, it is determined whether the training epoch t corresponds to one of 1,000, 2,000, 3,000, . . . , and 1,000*n (in which n is a natural number) is determined. When the training epoch t is determined not to correspond to the multiple of the check epoch, operation 760 is performed.

In operation 760, the model training apparatus increments the training epoch t by “1.” Also, the process reverts to operation 730 to train the student model θ_{S}.

When the training epoch t is determined to correspond to the multiple of the check epoch in operation 750, operation 770 is performed.

In operation 770, the model training apparatus acquires a recognition result \tilde{y} that is output from the student model θ_{S} when the training input s is input to the student model θ_{S}.

In operation 780, the model training apparatus calculates an error rate between the recognition result ŷ of the teacher model θ_{T} and the recognition result \tilde{y} of the student model θ_{S}. The calculated error rate is reflected on to the loss function, to update the loss function that is to be used for training of the student model θ_{S}. IN an example, the loss function is updated at every check epoch by calculating the error rate between the recognition result ŷ of the teacher model θ_{T} and the recognition result \tilde{y} of the student model θ_{S}. Thus, a degree to which a loss between the recognition result ŷ of the teacher model θ_{T} and the recognition result \tilde{y} of the student model θ_{S} is reflected to the loss function is adaptively adjusted based on a degree to which the student model is trained. In another example, a degree to which a loss between the correct answer and a recognition result of a teacher model is reflected to the loss function is adaptively adjusted based on a degree to which the student model is trained.

In operation 760, the training epoch t is incremented by “1,” and the student model θ_{S} is trained based on the updated loss function in operation 730.

For example, when the training epoch t is determined to be greater than or equal to the maximum epoch in operation 740, operation 790 is performed. In operation 790, the model training apparatus terminates the training of the student model θ_{S}.

Operations 710 through 790 of FIG. 7 correspond to an example in which the error rate between the recognition result of the teacher model and the recognition result of the student model and the error rate between the correct answer and the recognition result of the teacher model are simultaneously applied to the loss function.

In an example, when operation 720 is not performed, the process of reflecting the error rate between the recognition result of the teacher model and the recognition result of the student model to the loss function is performed as shown in FIG. 4. In another example, when operations 750, 770 and 780 are not performed, the process of reflecting the error rate between the correct answer and the recognition result of the teacher model to the loss function is performed as shown in FIG. 5. In this example, when the training epoch t is less than the maximum epoch in operation 740, operation 760 is performed.

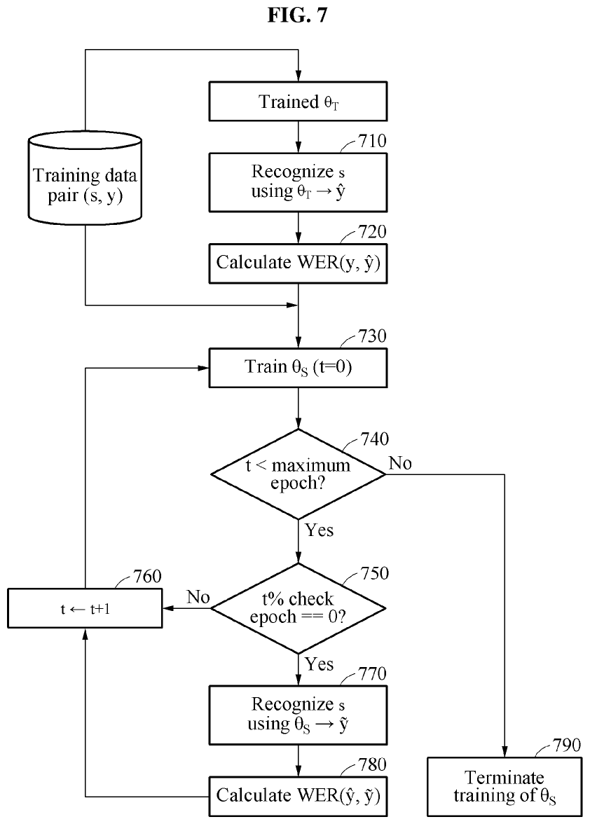

FIG. 8 illustrates an example of a model training method. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. One or more blocks of FIG. 8, and combinations of the blocks, can be implemented by special purpose hardware-based computer that perform the specified functions, or combinations of special purpose hardware and computer instructions. For example, the model training method of FIG. 8 is performed by a processor of a model training apparatus. In addition to the description of FIG. 8 below, the descriptions of FIGS. 1-7 are also applicable to FIG. 8, and are incorporated herein by reference. Thus, the above description may not be repeated here.

In operation 810, the model training apparatus determines a loss function to train a student model.

In an example, the model training apparatus determines the loss function by reflecting an error rate between a recognition result of a teacher model and a recognition result of the student model to the loss function. In an example, the model training apparatus determines the loss function so that a contribution rate of the teacher model to training of the student model increases when the error rate between the recognition result of the teacher model and the recognition result of the student model increases.

In another example, the model training apparatus determines the loss function by reflecting an error rate between a correct answer and the recognition result of the teacher model to the loss function. In an example, the model training apparatus determines the loss function so that a contribution rate of the teacher model to training of the student model increases when the error rate between the correct answer and the recognition result of the teacher model decreases.

In another example, the model training apparatus reflects both the error rate between the recognition result of the teacher model and the recognition result of the student model and the error rate between the correct answer and the recognition result of the teacher model to the loss function and determines the loss function.

In operation 820, the model training apparatus trains the student model based on the loss function. For example, the model training apparatus trains the student model so that a loss caused by the loss function is minimized.

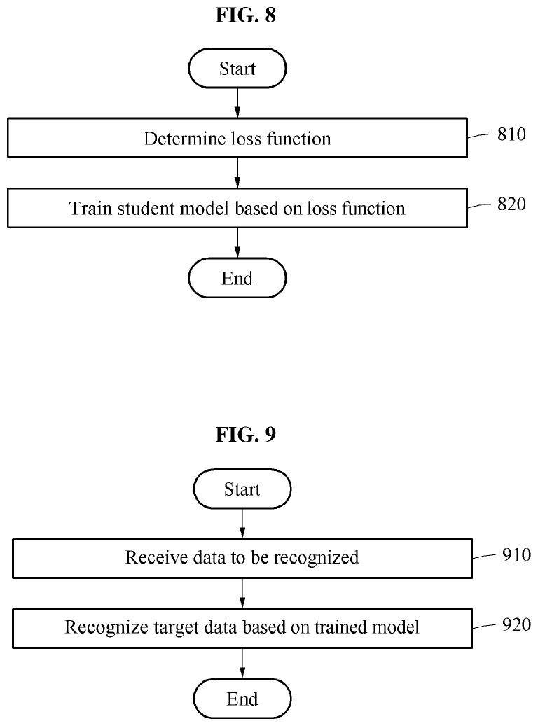

FIG. 9 illustrates an example of a data recognition method. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. One or more blocks of FIG. 9, and combinations of the blocks, can be implemented by special purpose hardware-based computer that perform the specified functions, or combinations of special purpose hardware and computer instructions. For example, the data recognition method of FIG. 9 is performed by, for example, a processor of a data recognition apparatus. In addition to the description of FIG. 9 below, the descriptions of FIGS. 1-8 are also applicable to FIG. 9, and are incorporated herein by reference. Thus, the above description may not be repeated here.

In operation 910, the data recognition apparatus receives target data that is to be recognized. The target data includes, for example, audio data, text data, image data, or various combinations thereof. A data recognition includes, for example, a speech recognition, a translation, an object recognition, or a user authentication.

In operation 920, the data recognition apparatus recognizes the target data using a trained student model. In an example, the student model is trained based on a loss function that is determined by reflecting an error rate between a recognition result of a teacher model and a recognition result of the student model.

In an example, the loss function is determined by reflecting the error rate between the recognition result of the teacher model and the recognition result of the student model. In another example, the loss function is determined by reflecting an error rate between a correct answer and the recognition result of the teacher model. In another example, the loss function is determined by reflecting both the error rate between the recognition result of the teacher model and the recognition result of the student model and the error rate between the correct answer and the recognition result of the teacher model.

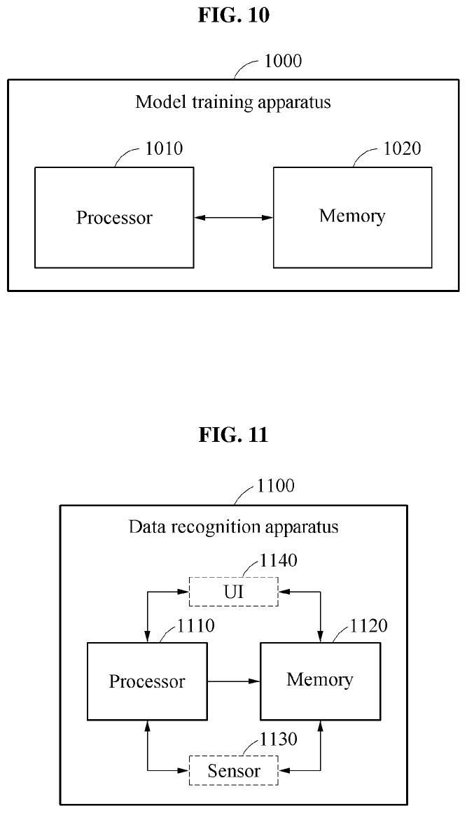

FIG. 10 illustrates an example of a model training apparatus 1000.

Referring to FIG. 10, the model training apparatus 1000 includes a processor 1010 and a memory 1020. The model training apparatus 1000 is an apparatus configured to train a student model for a data recognition, and is implemented as, for example, a single processor or multi-processor.

In an example, the processor 1010 determines a loss function by reflecting an error rate between a recognition result of a teacher model and a recognition result of a student model to the loss function, and trains the student model based on the loss function.

In an example, the processor 1010 performs at least one method described above with reference to FIGS. 1 to 9 or an algorithm corresponding thereto.

The processor 1010 refers to a data processing device configured as hardware with a circuitry in a physical structure to execute desired operations. For example, the desired operations may include codes or instructions included in a program. For example, the data processing device configured as hardware may include a microprocessor, a central processing unit (CPU), a processor core, a multicore processor, a multiprocessor, an application-specific integrated circuit (ASIC), and a field programmable gate array (FPGA). The processor 1010 executes the program and controls the neural network. In an example, the processor 1010 may be a graphics processor unit (GPU), reconfigurable processor, or have any other type of multi- or single-processor configuration. The program code executed by the processor 1010 is stored in the memory 1020. Further details regarding the processor 1010 is provided below.

The memory 1020 stores the teacher model and the student model. The student model is, for example, a student model trained by the processor 1010. In an example, the memory 1020 stores the information to train the teacher model and the student model. The memory 1020 stores a variety of information generated during the processing at the processor 1010. In addition, a variety of data and programs may be stored in the memory 1020. The memory 1020 may include, for example, a volatile memory or a non-volatile memory. The memory 1020 may include a mass storage medium, such as a hard disk, to store a variety of data. Further details regarding the memory 1020 is provided below.

The above description of FIGS. 1 through 9 is equally applicable to the model training apparatus 1000, and thus further description thereof is not repeated herein.

FIG. 11 illustrates an example of a data recognition apparatus 1100.

Referring to FIG. 11, the data recognition apparatus 1100 includes a processor 1110, a memory 1120, a sensor 1130, and a UI 1140. The data recognition apparatus 1100 is an apparatus configured to recognize data using a trained student model, and is implemented as, for example, a single processor or multi-processor.

The processor 1110 receives target data that is to be recognized, and recognizes the target data using a trained student model. In an example, the student model is trained based on a loss function that is determined by reflecting an error rate between a recognition result of a teacher model and a recognition result of the student model. In an example, the processor 1110 performs at least one method described above with reference to FIGS. 1 to 10 or an algorithm corresponding thereto.

The processor 1110 refers to a data processing device configured as hardware with a circuitry in a physical structure to execute desired operations. For example, the desired operations may include codes or instructions included in a program. For example, the data processing device configured as hardware may include a microprocessor, a central processing unit (CPU), a processor core, a multicore processor, a multiprocessor, an application-specific integrated circuit (ASIC), and a field programmable gate array (FPGA). The processor 1110 executes the program and controls the neural network. In an example, the processor 1110 may be a graphics processor unit (GPU), reconfigurable processor, or have any other type of multi- or single-processor configuration. The program code executed by the processor 1110 is stored in the memory 1120. Further details regarding the processor 1110 is provided below.

The memory 1120 includes the student model. For example, the memory 1120 stores a student model that is completely trained. In an example, the memory 1120 stores the information to train the teacher model and the student model. The memory 1120 stores a variety of information generated during the processing at the processor 1110. In addition, a variety of data and programs may be stored in the memory 1120. The memory 1120 may include, for example, a volatile memory or a non-volatile memory. The memory 1120 may include a mass storage medium, such as a hard disk, to store a variety of data. Further details regarding the memory 1120 is provided below.

The sensor 1130 includes, for example, a microphone and/or an image sensor. In an example, the sensor 1130 is camera to sense video data, for example. In another example, the camera is configured to recognize audio input, for example. In another example, the sensor 1130 senses both the image data and the voice data. In an example, the sensor 1130 senses a voice using a well-known scheme, for example, a scheme of converting an voice input to an electronic signal. An output of the sensor 1130 is transferred to the processor 1110 or the memory 1120, and output of the sensor 1130 may also be transferred directly to, or operate as, an input layer of the trained student model discussed herein.

In an example, the recognition result of the student model may be output through the display or the UI 1140. The display or the UI 1140 is a physical structure that includes one or more hardware components that provide the ability to render a user interface and/or receive user input. However, the display or the UI 1140 is not limited to the example described above, and any other displays, such as, for example, smart phone and eye glass display (EGD) that are operatively connected to the data recognition apparatus 1100 may be used without departing from the spirit and scope of the illustrative examples described. In an example, user adjustments or selective operations of the neural network processing operations discussed herein may be provided by display or the UI 1140, which may include a touch screen or other input/output device/system, such as a microphone or a speaker.

The above description of FIGS. 1 through 10 is equally applicable to the data recognition apparatus 1100, and thus further description thereof is not repeated herein.

The model training apparatus 1000, the data recognition apparatus 1100, and other apparatuses, units, modules, devices, and other components described herein with respect to FIGS. 10 and 11 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software includes at least one of an applet, a dynamic link library (DLL), middleware, firmware, a device driver, an application program storing the method of outputting the state information. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, card type memory such as multimedia card, secure digital (SD) card, or extreme digital (XD) card, magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A model training method comprising:
determining a loss function based on an error rate between a recognition result of a teacher model and a recognition result of a student model; and
training the student model based on the loss function.

2. The model training method of claim 1, wherein the determining of the loss function comprises determining the loss function so that a contribution rate of the teacher model to training of the student model is increased in response to an increase in the error rate between the recognition result of the teacher model and the recognition result of the student model.

3. The model training method of claim 1, wherein a contribution of the error rate between the recognition result of the teacher model and the recognition result of the student model is selectively adjusted based on an error between a correct answer and a recognition result of the student model.

4. The model training method of claim 1, wherein the determining of the loss function comprises determining the loss function so that a contribution rate of a loss between the recognition result of the teacher model and the recognition result of the student model to the loss function is increased in response to an increase in the error rate between the recognition result of the teacher model and the recognition result of the student model.

5. The model training method of claim 1, wherein the error rate between the recognition result of the teacher model and the recognition result of the student model is updated at a training epoch of the student model.

6. The model training method of claim 1, wherein the loss function is further determined based on an error rate between a correct answer and the recognition result of the teacher model.

7. The model training method of claim 6, wherein the determining of the loss function comprises determining the loss function so that a contribution rate of the teacher model to training of the student model is increased in response to a decrease in the error rate between the correct answer and the recognition result of the teacher model.

8. The model training method of claim 1, wherein
the determining of the loss function comprises determining the loss function by applying a first factor to the error rate between the recognition result of the teacher model and the recognition result of the student model,
wherein the first factor is controlled so that a contribution of the teacher model to training of the student model decreases in response to an increase in a training epoch of the student model.

9. The model training method of claim 1, wherein the loss function is further based on a loss between a correct answer and the recognition result of the teacher model.

10. The model training method of claim 9, wherein
a contribution of the loss between the correct answer and the recognition result of the teacher model and the loss between the recognition result of the teacher model and the recognition result of the student model to the loss function is adjusted by a second factor,
wherein the second factor is controlled so that a contribution of the teacher model to training of the student model decreases and a contribution of the correct answer increases, in response to an increase in a training epoch of the student model.

11. A non-transitory computer-readable storage medium storing instructions that, when executed by a processor, cause the processor to perform the model training method of claim 1.

12. A model training method comprising:
determining a loss function based on an between a correct answer and a recognition result of a teacher model; and
training a student model based on the loss function.

13. The model training method of claim 12, wherein the determining of the loss function comprises determining the loss function so that a contribution rate of the teacher model to training of the student model is increased, in response to a decrease in the error rate between the correct answer and the recognition result of the teacher model.

14. The model training method of claim 12, wherein a contribution of the error rate between the correct answer and a recognition result of a teacher model is selectively adjusted based on an error between a correct answer and a recognition result of the student model.

15. The model training method of claim 12, wherein the determining of the loss function comprises determining the loss function so that a contribution rate of a loss between the correct answer and the recognition result of the teacher model to the loss function is increased, in response to a decrease in the error rate between the correct answer and the recognition result of the teacher model.

16. The model training method of claim 12, the loss function is further determined based on an error rate between the recognition result of the teacher model and a recognition result of the student model.

17. A data recognition method comprising:
receiving target data to be recognized; and
recognizing the target data using a student model,
wherein the student model is trained based on a loss function determined by reflecting an error rate between a recognition result of a teacher model and a recognition result of the student model.

18. A model training apparatus comprising:
a memory configured to store a teacher model and a student model; and
a processor configured to determine a loss function based on an error rate between a recognition result of the teacher model and a recognition result of the student model, and to train the student model based on the loss function.

19. The model training apparatus of claim 18, wherein the processor is further configured to determine the loss function so that a contribution rate of the teacher model to training of the student model is increased, in response to an increase in the error rate between the recognition result of the teacher model and the recognition result of the student model.

20. The model training apparatus of claim 18, wherein the processor is further configured to determine the loss function by reflecting an error rate between a correct answer and the recognition result of the teacher model to the loss function.

21. The model training apparatus of claim 18, wherein
the processor is further configured to determine the loss function by applying a first factor to the error rate between the recognition result of the teacher model and the recognition result of the student model,
wherein the first factor is controlled so that a contribution of the teacher model to training of the student model decreases, in response to an increase in a training epoch of the student model.
